(19) United States
(12) Patent Application Publication
(10) Pub. No.: US 2013/0163986 A1
(43) Pub. Date: Jun. 27, 2013

(54) ELECTRICALLY-ADAPTIVE DSPK AND (D)MPSK RECEIVERS

(71) Applicants: Pavel Mamyshev, Morganville, NJ (US); John Leonard Zyskind, Concord, MA (US); Seo Yeon Park, Westford, MA (US); Fenghai Liu, Acton, MA (US)

(72) Inventors: Pavel Mamyshev, Morganville, NJ (US); John Leonard Zyskind, Concord, MA (US); Seo Yeon Park, Westford, MA (US); Fenghai Liu, Acton, MA (US)

(73) Assignee: OCLARO TECHNOLOGY LIMITED, Northamptonshire (GB)

(21) Appl. No.: 13/641,078

(22) PCT Filed: Apr. 15, 2011
(86) PCT No.: PCT/US2011/032703

§ 371 Date: Feb. 21, 2013

Related U.S. Application Data
(60) Provisional application No. 61/324,561, filed on Apr. 15, 2010.

(51) Int. Cl. H04B 10/2507

(52) U.S. Cl. CPC H04B 10/2507
USPC 398/25; 398/135

(57) ABSTRACT

The present application describes methods and systems that improve the optical signal to noise ratio performance of an optical network without the need to vary the free spectral range associated with a differential interferometer. This is achieved by varying an electrical bandwidth of an electronic device associated with the receiver. For example, the electrical bandwidth may vary in inverse proportion to the combined effective optical bandwidth of the transmission line carrying the optical signal. The techniques described herein a applicable to a wide variety of modulation formats, including mPSK, DPSK, DmPSK, PDmPSK, mQAM, ODB, and other direct-detection formats. Using the techniques described herein, the optical signal to noise ratio and bit error ratio performance of the optical network is improved without the need to provide costly and complex differential interferometers whose free spectral range is variable.

### RELATED APPLICATIONS

This application claims priority to U.S. Provisional Patent Application Ser. No. 61/324,561, filed on Apr. 15, 2010, the contents of which are incorporated herein by reference.

### BACKGROUND

This invention generally relates to optical communications, and in particular to a method and system for converting an optical signal into an electrical signal in an optical communications network.

The backbone of point-to-point information transmission networks is a system of optically amplified dense wavelength division multiplex (DWDM) optical links. DWDM optical fiber transmission systems operating at channel rates of 40 Gb/s and higher are highly desirable because they potentially have greater fiber capacity and also have lower cost per transmitted bit compared to lower channel rate systems.

The modulation format of 40 Gb/s DWDM transmission systems is typically chosen to have high Optical Signal-to-Noise Ratio (OSNR) sensitivity. High OSNR sensitivity means that a low OSNR is sufficient to maintain a desired bit error ratio (BER) of the transmission or, equivalently, that the system is able to operate at a desired BER even in the presence of a high level of optical noise. In addition, modulation formats of 40 Gb/s DWDM transmission systems are typically chosen to be tolerant to optical filtering because existing systems sometimes include optical multiplexers and demultiplexers for 50 GHz channels spacing that limit the bandwidth. Also, existing systems sometimes include cascaded optical add-drop multiplexers.

Accordingly, Differential Phased Shift Keying (DPSK) has been considered for 40 Gb/s DWDM transmission systems, in part because DPSK transmission systems have excellent OSNR sensitivity. DPSK transmission systems using balanced direct detection receivers, which are sometimes referred to as differential receivers, have been shown to have an approximately 3 dB improvement of OSNR sensitivity compared to on-off keying systems, such as NRZ and PSBT systems. However, conventional DPSK transmission systems do not have good filter tolerance.

In a DPSK system, data is encoded onto a carrier wave by shifting the phase of the carrier wave. The amount of the phase shift may be selected based on the amount of data to be encoded with each phase shift. For example, in Differential Binary Phase Shift Keying (DBPSK), the phase of the signal may be shifted in increments of 180° (i.e., by it radians) in order to encode a single bit of data (“1” or “0”) with each phase shift. In Differential Quadrature Phase Shift Keying (DQPSK), the phase of the signal may be shifted in increments of 90° (i.e., by π/2 radians) in order to encode two bits of data (e.g., “11” or “01”) with each phase shift.

The number of possible phase shifts is typically referred to as the number of “constellation points” of a modulation format. For example, DBPSK has two constellation points, and DQPSK has four constellation points. Modulation formats using different number of constellation points (e.g., “m” constellation points) are also known, and are referred to generically as DmPSK formats.

If both the phase of the signal and the amplitude of the signal are used to encode the signal with the data, then the modulation format is called QAM (quadrature amplitude modulation) or m-QAM, where m is the number of constellation points.

A shift in the phase of the signal is referred to as transmitting a “symbol,” and the rate at which each symbol is transmitted is referred to as the “symbol rate.” As noted above, multiple bits of data may be encoded with each symbol. The rate at which bits are transmitted is referred to as the “bit rate.” Thus, the symbol rate in a DQPSK system is half the bit rate. For example, a DBPSK system and a DQPSK each transmitting at the same symbol rate would evidence different bit rates—the DQPSK system would have a bit rate that is twice the bit rate of the DBPSK system.

Accordingly, a 43 Gb/s data rate in a DQPSK system corresponds to 21.5 Giga symbols per second. Thus, DQPSK transmission systems have a narrower spectral bandwidth, greater chromatic dispersion tolerance and greater tolerance with respect to polarization mode dispersion (PMD) compared to traditional formats and compared to DBPSK. However, DQPSK transmission systems have approximately 1.5-2 dB worse receiver sensitivity than DBPSK transmission systems. Furthermore, both the transmitter and the receiver are significantly more complex than a traditional DBPSK transmitter/receiver.

DBPSK and DQPSK can be of the non-return-to-zero (NRZ)-type or, if a return-to zero (RZ) pulse carver is added to the transmitter, may be of the RZ-type.

FIG. 1A is a block diagram describing an example of optical network 100 for transmitting, among other things, a DQPSK optical signal.

A transmitter 102 may generate a DQPSK optical signal 104. The transmitter 102 may include, for example, a light source such as a light emitting diode (LED) or laser. A pulse carver may accept a beam of light from the light source and add a pulse to the beam of light. The pulsed beam may have a phase which can be manipulated by one or more interferometers in order to encode a data signal on the beam of light. The manipulated beam may be a DQPSK optical signal 104.

The DQPSK optical signal 104 may be combined with one or more on-off-keyed (OOK) signals 106 at a multiplexer 107. For example, the signals may be multiplexed using wavelength division multiplexing (WDM), and two neighboring signals may have relatively similar wavelengths. By multiplexing the signals 104, 106 together and/or filtering the signals using one or more optical filters 108, more information can be carried over a transmission line 109. The filters 108 may include, for example, multiplexers, demultiplexers, optical interleavers, optical add/drop filters, and wavelength-selective switches. The filters 108 may spectrally narrow the signal passing therethrough.

The combined optical signal carried on the transmission line 109 may be received at a receiver 110 for demodulating the combined optical signal. Prior to the receiver 110, a demultiplexer 111 may receive a multiplexed signal. The demultiplexer 111 may select one of the signals, for example the DQPSK signal 104. The demultiplexer 111 may select the signal, for example, by isolating a particular wavelength carrying the DQPSK signal 104. Alternatively, the receiver 110 may include a demultiplexer 111 or selector for receiving an incoming modulated optical signal.

The receiver 110 includes a splitter 112 for splitting the DQPSK signal 104 into two or more source beams 113, 114. The first source beam 113 is received at a first interferometer 116, and the second source beam 114 is received at a second interferometer 119.

DPSK/DQPSK receivers typically use one or more optical demodulators that convert the phase modulation of the transmitted optical signal into amplitude modulated signals that can be detected with direct detection receivers. Typically, optical demodulators are implemented as delay interferometers (DIs) 116, 119 that split the optical signal into two parts, delay one part relative to the other by a differential delay Δt, and finally recombine the two parts to achieve constructive or destructive interference depending on the phase which is modulated onto the optical signal at the transmitter 102. Thus, the interferometer may interfere a DPSK or a DQPSK optical signal with itself.

The optical demodulator converts the DPSK/DQPSK phase-modulated signal into an amplitude-modulated optical signal at one output and into the inverted amplitude-modulated optical signal at the other output. These signals are detected with a photodetector 120, which may consist (for example) of two high-speed detectors (see, e.g., FIG. 1B). The outputs of the detectors are electrically subtracted from each other, and after that the resultant electrical signal is sent to the data recovery circuits.

In operation, the interferometers 116, 119 shift the phase of the incoming signals.

For example, in a DQPSK system, the interferometers 116, 118 may shift the phase of the incoming signals relative to each other by π/2. To achieve such a shift, for example, the first interferometer 116 may shift the phase of the signal by π/4, and the second interferometer 118 may shift the phase of the signal by π/4.

The interferometers 116, 119 are used to analyze and/or demodulate the incoming modulated optical signal 102, and provide their outputs to one or more detectors 120, 122. The interferometers 116, 119 are described in more detail below with reference to FIGS. 1B-1D.

Each of the interferometers may generate one or more optical inputs to a photodetector. For example, the first interferometer 116 may generate a first optical input 117 and a second optical input 118 that are provided to a photodetector 120. Similarly, the second interferometer 119 may provide optical inputs to a second photodetector 122. The first and second photodetectors 120, 122 may operate on the input optical signals and generate first and second electrical output signals 124, 126, respectively. The photodetectors may be, for example, balanced or unbalanced detectors.

FIG. 1B is a block diagram of a portion of the receiver 110 of FIG. 1A. In the receiver, a first interferometer 116 and a first photodetector 120 cooperate to turn a first optical source beam 113 in the optical domain into a first electrical output signal 124 in the electrical domain.

At the first interferometer 116, the first optical source beam 113 is split into a sample beam 128 and a reference beam 130. The sample beam 128 and reference beam 130 are processed to generate a first optical input 117 and a second optical input 119, which are respectively received by first and second detectors 132, 134 in the photodetector 120. The first and second detectors 132, 134 output a first optical output 136 and a second optical output 138, respectively, to an electronic device 140. The electronic device 140 may be, for example, a differential detector that subtracts the first optical output 136 from the second optical output 138 in order to generate the first electrical output signal 124.

FIG. 1C is an example of an interferometer, such as (for example) interferometer 116. The interferometer 116 may be, for example, an unbalanced Mach-Zehnder interferometer (MZI) or a delay line interferometer (DLI) which receives one of the signal components (e.g., the first source beam 113) from the splitter 112. The interferometer 116 may be fabricated, for example, in gallium arsenide or lithium niobate.

The interferometer 116 may include a first splitter 142 for splitting the received first source beam 113 into two or more interferometer signal components 128, 130. The first interferometer signal component 128 is referred to as the sample beam, and is provided to a first mirror 148 along an optical path 144. Likewise, a reference beam 130 is supplied to a second minor 150 along a second optical path 146. The optical paths 144, 146 may include an optical medium through which the signals travel. For example, the optical paths 144, 146 may include air or glass. The optical properties of the medium in the optical paths 144, 146 affect the amount of time that it takes the signals 128, 130 to travel in the optical paths 144, 146.

From the mirrors 148 and 150, the respective interferometer signal components 128 and 130 are provided to another splitter 152, where the signal is further split into a pair of signals (a first optical input 117 and a second optical input 119), which are received by two or more detectors 136, 134.

If the optical paths 144, 146 (or other optical paths not pictured) are identical in length and other properties, then the sample beam 128 and the reference beam 130 arrive at the detectors 134, 136 at the same time. However, by varying one or more of the optical paths 144, 146 with respect to the other, a time delay can be introduced, as shown in FIG. 1D.

As depicted in FIG. 1D, each interferometer 116, 118 may be unbalanced in that each interferometer has a time delay 410 (often referred to by the symbol “τ”), which in some situations may be equal to the symbol period (e.g., 50 ps for a 20 Gsymbol/s line rate) of the data modulation rate, in one optical path 144 relative to that of the other optical path 146. The time delay 410 affects the time at which each respective beam 128, 130 is received at the detectors 132, 134.

One “symbol period” is often used as the time delay 410 value in interferometers. More specifically, using quadrature phase shift keying, the phase of a signal may be shifted in four different ways (by 0, π/2, π, and 3π/2). Accordingly, each phase shift can encode a signal having two bits of information (e.g., “00,” “01,” “10,” “11”). The symbol rate refers to the rate at which these “symbols” are transmitted in the network (e.g., the number of symbol changes made to the transmission medium per second), while the symbol period refers to the amount of time that it takes for a single symbol to be transmitted. For example, if it takes 46.5 ps (i.e., 4.65×10⁻¹¹ seconds) to transmit a single symbol, then the symbol period is 46.5 ps and the symbol rate is approximately 2.15−10⁻¹⁰ symbols per second (or 21.5 Gsymbol/s).

Conventional interferometers include a time delay 154 in order to determine the amount that a particular signal has been phase shifted. Conventionally, the time delay 154 may be set to (for example) one symbol period in order to aid in the interpretation of the phase shifted signal. However, the time delay 154 may also be set to be larger or smaller than the symbol period, as discussed in U.S. patent application Ser. No. 12/906,554, entitled “Method And System For Deploying An Optical Demodulator Arrangement In A Communications Network” and filed Oct. 18, 2010, the contents of which are incorporated herein by reference.

In the “classical” implementation of DPSK receivers, the time delay 154 between the two arms of the interferometer is an integer number of the time symbol slots of the optical DPSK data signal: Δt=n T (where n=1, 2, . . . T; T=1/B is the symbol time slot; and B is the symbol bit-rate).

The time delay 154, may be introduced by making the optical path length of the two optical paths 144, 146 different, or may be introduced by varying the medium through which one of the signals 128, 130 travels, among other things. For ease of fabrication, the time delay 154 may be introduced by making the physical length of the interferometer's 116 optical path 144 longer than the physical length of the other optical path 146.

Each interferometer 116, 118 is respectively set to impart a relative phase shift 156 by the application of an appropriate voltage to electrodes on the shorter optical path 146. The amount of the phase shift 156 may be determined, for example, based on the modulation format. In the example of DQPSK, the relative phase shift 156 may be π/4 or −πn/4. In the example of DPSK, the relative phase shift 156 may be π or 0. A more detailed description of the interferometers and time delay can be found in U.S. patent application Ser. No. 10/451,464, entitled “Optical Communications,” the contents of which are incorporated herein by reference.

Changing the amount of time delay 154 can change the Free Spectral Range (FSR) of the interferometer 116. The FSR relates to the spacing in optical frequency or wavelength between two successive reflected or transmitted optical intensity maxima or minima of, for example, an interferometer. The FSR may also be modified through the multiplexer 107, optical filter 108, or other components of the optical network 100.

Conventionally, an FSR of an interferometer is modified in accordance with a change in the optical bandwidth of the optical signal passing through the interferometer. Until recently, it was a common understanding that the best performance (best optical signal-to noise ratio OSNR sensitivity) is obtained when the time delay between the two arms of the interferometer Δt is exactly an integer number of the time symbol slots of the optical DPSK/DQPSK data signal (Eq. 1) [1], and the penalty increases rapidly (˜ quadratically) when Δt deviates from its optimal value (see, for example, Peter J. Winzer and Hoon Kim, “Degradation in Balanced DPSK receivers”, IEEE PHOTONICS TECHNOLOGY LETTERS, vol. 15, no. 9, page 1282-1284, September 2003). In other words, according to conventional theory the optimum FSR (FSR=1/Δt) of the DI equals 1/nT, and (in case of n=1) equals the symbol rate of the signal.

The performance of DPSK modulated optical networks considerably reduces when the signal is spectrally narrowed (for example, after going through optical multiplexers/demultiplexers, optical interleavers, optical add/drop filters, wavelength-selective switches or other filters 108, when the symbol rate B is comparable to the channel spacing in WDM transmission, etc). To improve performance of DPSK/DQPSK in such bandwidth-limited transmission, a concept of Partial DPSK (P-DPSK) was introduced: by making the time delay between the two arms of the delay interferometer Δt smaller than the symbol size T (or, equivalently, making the DI FSR larger than the symbol rate: FSR>1/T), the performance of the optically-filtered DPSK was considerably improved (see, e.g., U.S. patent application Ser. No. 11/740,212, entitled “Partial DPSK (PDPSK) Transmission Systems” and filed on Apr. 25, 2007, the contents of which are incorporated herein by reference). It was shown that depending on the amount of the signal spectral filtering in the transmission system, an optimum FSR of the DI exists, and this optimum FSR is different for different strength of optical filtering.

Nevertheless, in practical systems the receiver should be able to operate in conditions with different amount of the signal spectral filtering in the transmission line: for example, the combined optical bandwidth of systems with reconfigurable optical add/drop multiplexers (ROADMs) can change dramatically depending on the number of ROADMs in the system and the ROADMs settings. To address this issue, it was proposed in the '212 application (supra) and is successfully being used in commercial systems, to use P-DPSK receivers with DIs whose FSR is mechanically switchable (or tunable). More succinctly, it is known to alter the FSR of a signal in response to a change in the optical bandwidth of the signal. Moreover, conventional wisdom dictates that when the optical bandwidth varies but the FSR is held constant, the signal quality quickly degrades. Accordingly, it is conventionally thought that the FSR must vary with the optical bandwidth in order to avoid rapid signal degradation.

Although this technique effectively lowers the OSNR of the signal, switchable/tunable DIs add complexity, cost and size. In addition, the traffic is interrupted while the FSR is changed.

### SUMMARY OF THE INVENTION

The present application describes methods and systems that improve the OSNR performance of an optical network without the need to vary the FSR associated with a DI. This is achieved by varying an electrical bandwidth of an electronic device associated with the receiver. For example, the electrical bandwidth may vary in inverse proportion to the combined effective optical bandwidth of the transmission line carrying the optical signal. Using the techniques described herein, the OSNR and BER performance of the optical network is improved without the need to provide costly and complex DIs whose FSR is variable.

According to an exemplary embodiment, a method is described for converting an optical signal transmitted in a transmission line of an optical communications network into an electrical signal. The optical signal may be, for example, a Differential Binary Phase Shift Keying (DBPSK) modulated signal or a Differential Quadrature Phase Shift Keying (DQPSK) modulated signal. The optical signal may also be a Partial Differential Phase Shift Keying (P-DPSK) modulated signal, which may be a P-DQPSK signal.

A first input signal may be received at an electronic device. The electronic device may be, for example, a trans-impedance amplifier (TIA) and/or an electric filter. The electronic device may be provided as part of a receiver for an optical network. The receiver may include, for example, a first optical detector and a second optical detector provided in respective arms of a Mach-Zehnder Interferometer (MZI).

The first input signal may represent data associated with the optical signal. For example, the first input signal may be an optical signal output by a detector associated with an interferometer.

The electrical bandwidth of the electronic device is varied in response to a characteristic associated with the optical signal. For example, the characteristic may be an optical bandwidth of a transmission line carrying the optical signal. The optical bandwidth may be a combined effective optical bandwidth that is based on a sum of an optical bandwidth of an optical signal as output by a multiplexer and respective optical bandwidths of one or more optical signals output by one or more optical filters in the optical network. The characteristic may be determined from the optical signal, such as by measuring or detecting the optical bandwidth of the optical signal.

The electrical bandwidth may be varied in an inverse relation to the optical bandwidth. For example, when the optical bandwidth increases, the electrical bandwidth may be made to decrease. When the optical bandwidth decreases, the electrical bandwidth may be made to increase. The electrical bandwidth may be varied using, for example, a control voltage applied to the electronic device. The electrical bandwidth may vary in the range of, for example, about 20 GHz to about 39 GHz.

Instructions for varying the electrical bandwidth of the electronic device may be encoded on a non-transitory electronic device readable storage medium holding one or more electronic device readable instructions.

The electronic device may generate an output signal, which may be (for example), a result of subtracting the input optical signal from another input optical signal.

Using the techniques described herein, a free spectral range (FSR) associated with a differential interferometer (DI) may be fixed, thus avoiding the complexity and expense of a variable DI.

### DESCRIPTION OF THE DRAWINGS

In the Figures, the same reference numbers are used to refer to the same elements throughout.

FIG. 1A is a schematic block diagram of a conventional optical network 100.

FIG. 1B is a schematic block diagram of a portion of the receiver 110 of the optical network 100 of FIG. 1A.

FIG. 1C depicts a portion of the interferometer 116 and photodetector 118 of FIG. 1A.

FIG. 1D depicts further aspects of the interferometer 116.

FIG. 2A depicts a portion of a receiver 110 according to an exemplary embodiment of the present invention.

FIG. 2B is a block diagram depicting further details of the electronic device 140, link 202, and electrical bandwidth control device 200 of FIG. 2A.

FIG. 2B is a block diagram depicting an alternative implementation of the electrical bandwidth control device 200 of FIG. 2A.

FIG. 3A is a flowchart describing a method for adjusting the electrical bandwidth of the electronic device 140 based on the optical bandwidth of an optical signal according to an exemplary embodiment of the present invention.

FIG. 3B is a flowchart describing a method for adjusting the electrical bandwidth of the electronic device 140 based on a bit error ratio of an electrical signal according to an exemplary embodiment of the present invention

FIG. 4 is a block diagram depicting an experimental setup for evaluating a Bit Error ratio for various electrical and optical bandwidth combinations.

FIG. 5 is a graph 500 showing a relationship between the bit error ratio and various electrical and optical bandwidth combinations for a simulation using the experimental setup of FIG. 4.

FIG. 6 is a graph 600 showing the relationship between the results of a simulation and an experiment in which the electrical bandwidth of the electronic device is varied in an inverse relationship to the optical bandwidth.

FIG. 7 is a graph 700 showing the performance of a P-DPSK system with fixed DI FSR and adaptive receiver electrical bandwidth versus the strength of the optical filtering in the transmission line.

FIG. 8 depicts another exemplary embodiment of the present invention.

FIG. 9 depicts still another exemplary embodiment of the present invention.

FIG. 10 depicts yet another exemplary embodiment of the present invention.

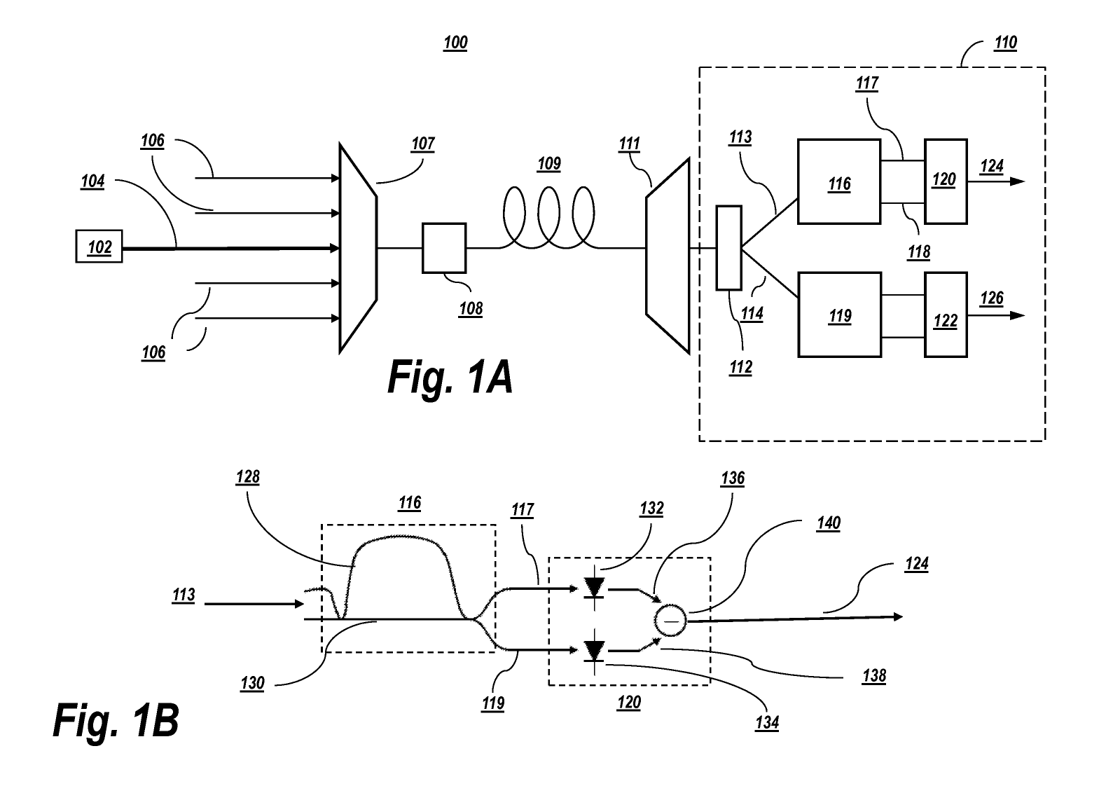

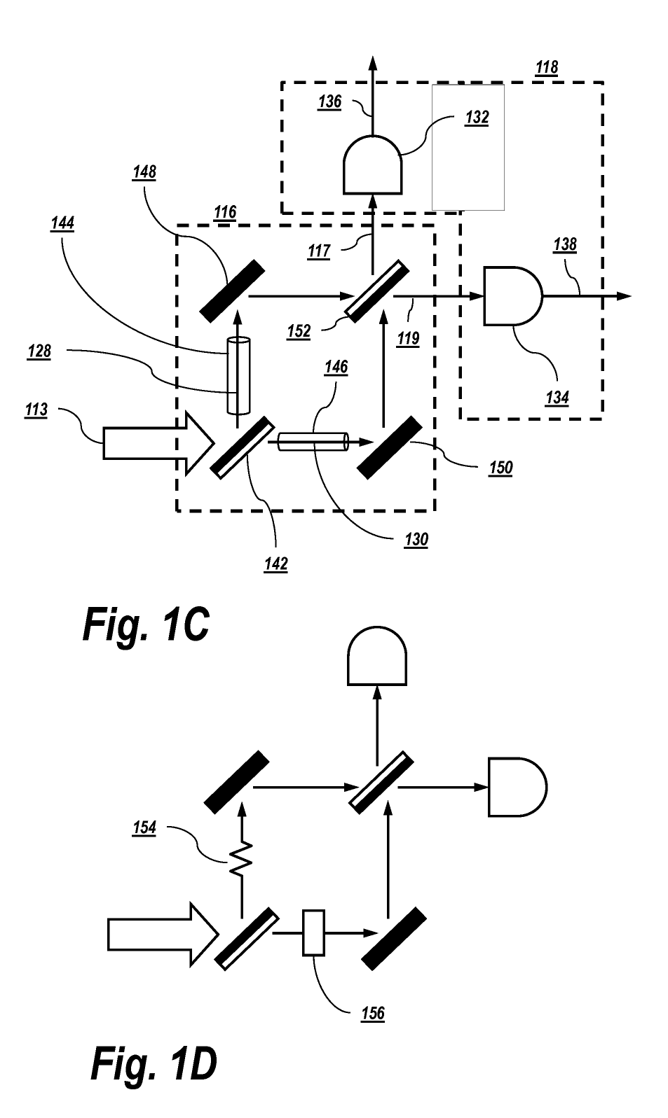

### DETAILED DESCRIPTION

The present inventors have discovered, unexpectedly and surprisingly, that the performance of a (P)DPSK receiver with a fixed DI FSR can be considerably improved over a wide range of optical filtering of an optical signal in the transmission line by adding adaptive electrical filtering at the receiver. According to exemplary techniques described herein, the OSNR performance of an optical network may be improved without the need to vary the FSR associated with a DI. More specifically, by varying an electrical bandwidth of an electronic device associated with the receiver, the OSNR and BER performance of the optical network is improved without the need to provide costly and complex DIs whose FSR is variable. For example, the electrical bandwidth may vary in inverse proportion to the combined effective optical bandwidth of the transmission line carrying the optical signal.

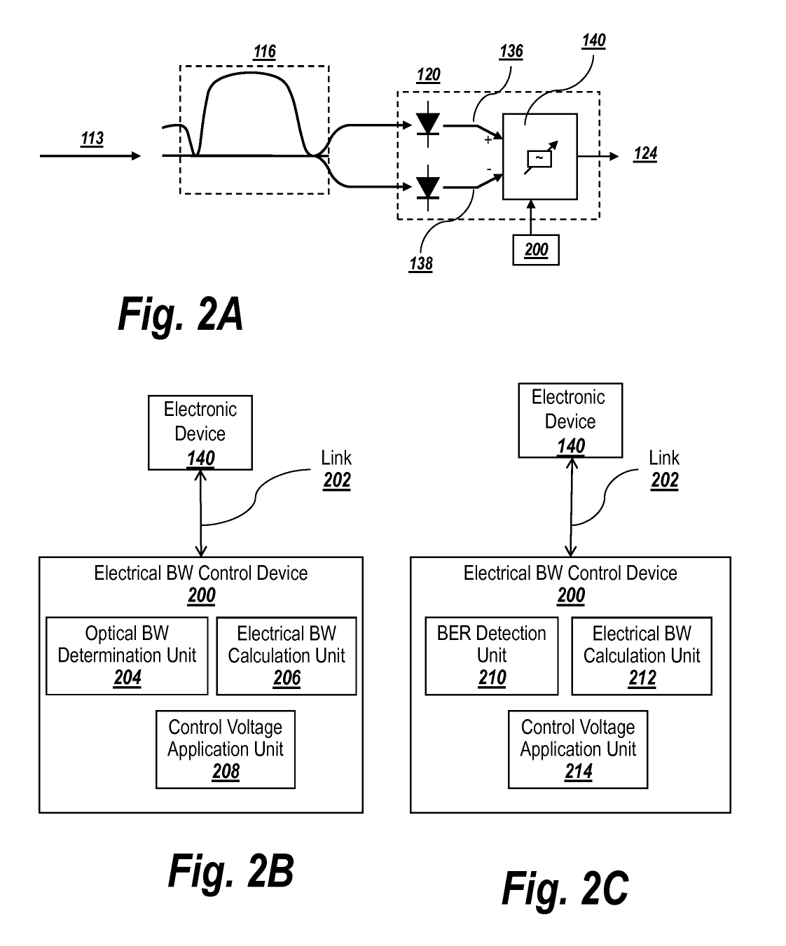

An exemplary mechanism for varying the electrical bandwidth of an electronic device in a receiver is depicted in FIGS. 2A-2B. For example, FIG. 2A depicts a portion of a receiver 110 according to an exemplary embodiment of the present invention.

As shown in FIG. 2A, a source beam 113 is provided to an interferometer 116. The interferometer splits the source beam 113 into a reference beam and a sample beam, and forwards the split beam components to a photodetector 120. Within the photodetector 120, two detectors receive the split beam components and output a first optical output 136 and a second optical output 138. The detectors may be, for example, high-speed photodiodes. The first and second optical outputs 136, 138 are received at an electronic device 140. The electronic device 140 may be, for example, a trans-impedance amplifier (TIA), electrical filter, or differential detector. The electronic device 140 may receive optical inputs, electrical inputs, or a combination of optical and electrical inputs. The electronic device may output an electrical signal.

The electronic device 140 may have a variable electronic bandwidth. A “bandwidth” represents the range of frequencies occupied by a signal, such as a modulated signal, and is typically measured in hertz (i.e., cycles per second). The modulated signal may be provided in a number of domains. For example, when the signal is an optical signal (i.e., the signal is in the optical domain), the signal is associated with an optical bandwidth. When the signal is an electrical signal (i.e., the signal is in the electrical domain), the signal is associated with an electrical bandwidth.

As a signal passes through a device, the device may be said to be operating at a bandwidth consistent with the signal. Further, the device may modify the bandwidth of the signal, such as by receiving a signal at a first bandwidth and outputting a signal at a second bandwidth.

The electronic bandwidth of the electronic device 140 (and, thus, the bandwidth of the receiver 110) may be made to vary. For example, the electronic bandwidth of the electronic device 140 may be made to vary in the range of about 20 GHz-about 39 GHz by applying a control voltage from a controller 200 to control the range of output frequencies of the electronic device 140. The range may be selected based on a number of factors, including (for example) the bitrate of the optical signal and the modulation format used.

In some embodiments, the electrical bandwidth of the receiver 110 may be made to vary by varying the bandwidth of the optical photodetectors (e.g., the detectors of the photodetector 120). Those of ordinary skill in the art will readily recognize that the range of frequencies can be varied based on the signal type and other system parameters.

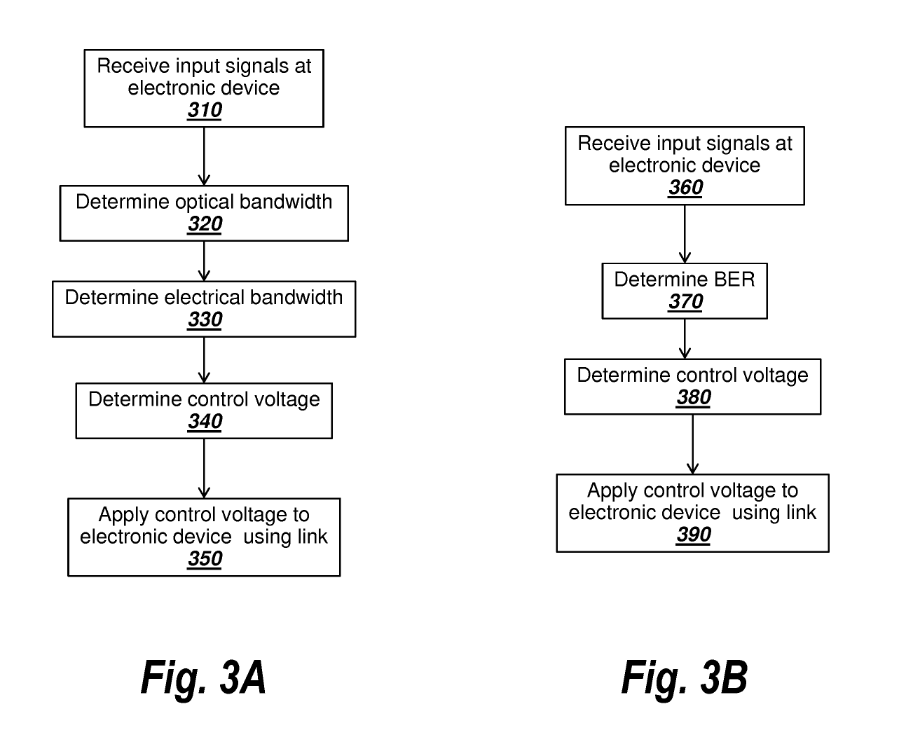

The control voltage may be applied by an electrical bandwidth control device 200 connected to the electronic device 140 via a link 202, as shown in FIG. 2B. The control device 200 may be, for example, a controller or a custom-designed hardware or software component, or combination of hardware and software. For example, the control device 200 may include a non-transitory electronic device readable medium storing instructions that, when executed by the control device, cause the control device to perform a method such as the method described in FIG. 3. The control device 200 may be integrated into the electronic device 140, or may be separate from the electronic device 140. Similarly, the electronic device 140 may be integrated into the photodetector 120 and/or receiver 110, or may be an entirely or partially separate component.

The link 202 may be a physical or logical connection between the electronic device 140 and the control device 200. For example, the link 202 may be a wire or a software interface to the electronic device 140. The link 202 may be bidirectional. For example, information regarding the optical bandwidth of a signal passing through the receiver 110 may be sent to the control device 200 through the link 202, and a control voltage (or instructions for applying a control voltage) may be sent from the control device 200 to the electronic device 140 through the link 202.

The control device 200 may include an optical bandwidth determination unit 204. The optical bandwidth determination unit 204 may determine the optical bandwidth of an optical signal traveling through the receiver 110. In operation, the optical bandwidth determination unit 204 may perform a number of steps as described in detail at step 320 of FIG. 3A.

The control device 200 may further include an electrical bandwidth calculation unit 206. The electrical bandwidth calculation unit 206 may calculate an appropriate electrical bandwidth to be applied by the electronic device that is based on the optical bandwidth determined by the optical bandwidth determination unit 204. The electrical bandwidth calculation unit 206 may further determine an appropriate control voltage to be applied to the electronic device 140 in order to cause the electronic device 140 to output an electrical signal in the electrical bandwidth range determined by the electrical bandwidth calculation unit 206. In operation, the optical electrical bandwidth calculation unit 206 may perform a number of steps as described in detail at step 330 of FIG. 3A.

The control device 200 may further include a control voltage application unit 208. The control voltage application unit 208 may apply the control voltage determined by the electrical bandwidth calculation unit 206. In operation, the control voltage application unit 208 may perform a number of steps as described in detail at step 350 of FIG. 3A.

In the embodiment depicted in FIG. 2B, a characteristic of the optical signal, such as the optical bandwidth, BER, OSNR, or FSR of a DI associated with the optical signal, may be used to determine the range of the electrical bandwidth. Varying the electrical bandwidth in an inverse relation to the optical bandwidth improves the OSNR, and therefore lowers the bit error ratio (BER) for the resulting electrical signal. In another embodiment, the BER may be used as a proxy for the optical bandwidth. That is, rather than (or in conjunction with) determining the optical bandwidth and modifying the electrical bandwidth based on the determined optical bandwidth, the BER of the resulting electrical signal (or an optical signal) may be measured and the electrical bandwidth of the electronic device may be varied based on the BER. For example, the electrical bandwidth may be modified to reduce and/or minimize the BER, as in the example depicted in FIG. 2C. One of ordinary skill in the art will recognize that other measures of signal quality or eye quality, other than the BER, may also be used as a proxy for the optical bandwidth.

The control device 200 of FIG. 2C may include a BER detection unit 210. The BER detection unit 210 may use forward error correction (FEC) to determine the BER. In operation, the control voltage application unit 208 may perform a number of steps as described in detail at step 370 of FIG. 3B.

Based on the BER determined by the BER detection unit 210, an electrical bandwidth calculation unit 212 may calculate an appropriate electrical bandwidth to be applied by the electronic device. The electrical bandwidth calculation unit 212 may further determine an appropriate control voltage to be applied to the electronic device 140 in order to cause the electronic device 140 to output an electrical signal in the electrical bandwidth range determined by the electrical bandwidth calculation unit 212. In operation, the optical electrical bandwidth calculation unit 212 may perform a number of steps as described in detail at step 380 of FIG. 3B.

The control device 200 may further include a control voltage application unit 214. The control voltage application unit 214 may apply the control voltage determined by the electrical bandwidth calculation unit 212. In operation, the control voltage application unit 208 may perform a number of steps as described in detail at step 390 of FIG. 3B.

As noted above, the control devices 200 of FIGS. 2B and 2C may perform a method in order to vary the electrical bandwidth of the electronic device 140. Exemplary methods are described below with respect to FIGS. 3A and 3B.

FIG. 3A is a flowchart describing a method for adjusting the electrical bandwidth of the electronic device 140 based on the optical bandwidth of an optical signal according to an exemplary embodiment of the present invention. The process may begin at step 310, when the receiver 110 receives an optical signal. For example, the optical signal may be generated by a transmitter 102 and multiplexed with other signals by a multiplexer 107. The signal may be passed through a number of optical filters 108 (before, during, or after passing the signal through the multiplexer 107) and transmitted over a transmission line 109. The receiver 110 may receive the signal at a selector or demodulator 111.

At step 320, the optical bandwidth determination unit 204 may determine the optical bandwidth of the optical signal. The optical bandwidth of the optical signal may be influenced by a variety of factors which are reflected in the optical bandwidth, such as one or more multiplexers and/or filters present in the transmission line 109. Accordingly, the bandwidth determined by the optical bandwidth determination unit 204 may be a combined effective optical bandwidth that is based on a sum of an optical bandwidth of an optical signal as output by a multiplexer and respective optical bandwidths of one or more optical signals output by one or more optical filters in the optical network. Information regarding the bandwidth of these components may be provided to the optical bandwidth determination unit 204 by the receiver 110, the filters 108, the modulator (e.g., the transmitter 102), the multiplexer 107, etc., or may be derived from the optical signal.

At step 330, the electrical bandwidth calculation unit 206 may calculate an appropriate electrical bandwidth to be applied by the electronic device that is based on the optical bandwidth determined by the optical bandwidth determination unit 204. For example, the electrical bandwidth calculation unit 206 may include a formula, equation, or method for translating an optical bandwidth into a suitable electrical bandwidth. In some embodiments, the electrical bandwidth calculation unit 206 may vary the electrical bandwidth of the electronic device according to both the optical bandwidth associated with the transmission line 109 and the FSR of the DI (e.g., in the case of DPSK and DQPSK). Alternatively, the electrical bandwidth calculation unit 206 may be programmed with a lookup table storing indexed optical bandwidths mapped to corresponding electrical bandwidths. The mapping may be determined, for example, using simulations of an optical network or through experimentation. When an optical bandwidth is determined by the optical bandwidth detection unit 204, the electrical bandwidth calculation unit 206 may consult the lookup table to determine an appropriate electrical bandwidth to be applied at the electronic device 140.

The electrical bandwidth calculation unit 206 may further determine an appropriate control voltage to be applied to the electronic device 140 in order to cause the electronic device 140 to output an electrical signal in the electrical bandwidth range determined by the electrical bandwidth calculation unit 206. For example, the electrical bandwidth calculation unit 206 may be programmed with a suitable formula, method, equation, or lookup table for mapping an electrical bandwidth range to a suitable control voltage.

At step 350, the control voltage application unit 208 may apply the control voltage determined at step 340 by the electrical bandwidth calculation unit 206. For example, the control voltage application unit may apply the determined control voltage via the link 202. Accordingly, the electronic device 140 may be made to output an electrical signal having an electrical bandwidth as determined by the electrical bandwidth calculation unit 206.

FIG. 3B depicts another embodiment of a method suitable for controlling the electrical bandwidth of the electronic device 140 using the bit error ratio of an electrical signal associated with the receiver 110.

At step 360, an input signal may be received by the electronic device 140. The input signal may be an optical signal received by the receiver 110 or output by one of the detectors 132, 134. For example, the optical signal may be generated by a transmitter 102 and multiplexed with other signals by a multiplexer 107. The signal may be passed through a number of optical filters 108 (before, during, or after passing the signal through the multiplexer 107) and transmitted over a transmission line 109. The receiver 110 may receive the signal at a selector or demodulator 111.

At step 370, the BER detection unit 210 may use forward error correction (FEC) to determine the BER. For example, redundant data such as error correcting code (ECC) may be transmitted over the transmission line 109 using the transmitter 102. The ECC may be predetermined and previously programmed into the BER detection unit 210. The ECC may be received at the receiver 110 and demodulated, and the resulting data or information may be compared to the preprogrammed ECC by the BER detection unit 210. The number of errors (e.g., measured in bits) over time may be used to determine the BER.

At step 380, the electrical bandwidth calculation unit 212 may calculate an appropriate electrical bandwidth to be applied by the electronic device that is based on the BER determined by the BER determination unit 210. For example, the electrical bandwidth calculation unit 212 may monitor the bit error ratio over time and calculate whether the electrical bandwidth of the electronic device 140 should be raised or lowered in response. The BER determination unit 210 may determine the appropriate direction and amount of variance of the electrical bandwidth using a feedback loop or control circuit. For example, if a first change in the electrical bandwidth of the electronic device 140 causes the BER to increase, the BER determination unit 210 may determine that the electrical bandwidth should be subsequently changed in the opposite direction.

In another embodiment, the electrical bandwidth calculation unit 212 may instruct the control voltage application unit 214 to dither the electrical bandwidth of the electronic device and thus find an appropriate electrical bandwidth by minimizing the BER (and/or maximizing the “signal quality” or the “eye quality”). To dither a signal, the bandwidth may be varied in a particular direction so that a change in signal quality can be observed. If the signal quality worsens, a change in the opposite direction may be made. If the signal quality improves, further changes may be made in the same direction until signal quality ceases to improve or worsens. Changes to the bandwidth may be repeated, and further changes may be made in response to the observed difference in signal quality. As the signal may be varying in real time, or subject to discrete change, the dithering could be constant or periodic. Dithering might be turned off to avoid affecting the signal.

The electrical bandwidth calculation unit 212 may further determine an appropriate control voltage to be applied to the electronic device 140 in order to change the electrical bandwidth of the electronic device 140 in the appropriate direction as determined by the electrical bandwidth calculation unit 212. For example, the electrical bandwidth calculation unit 212 may be programmed with a suitable formula, method, equation, or lookup table for mapping a desired electrical bandwidth change or variance to a suitable control voltage. The mapping may be determined, for example, using simulations of an optical network or through experimentation. When a BER is determined by the BER detection unit 210, the electrical bandwidth calculation unit 212 may consult the lookup table to determine an appropriate electrical bandwidth to be applied at the electronic device 140.

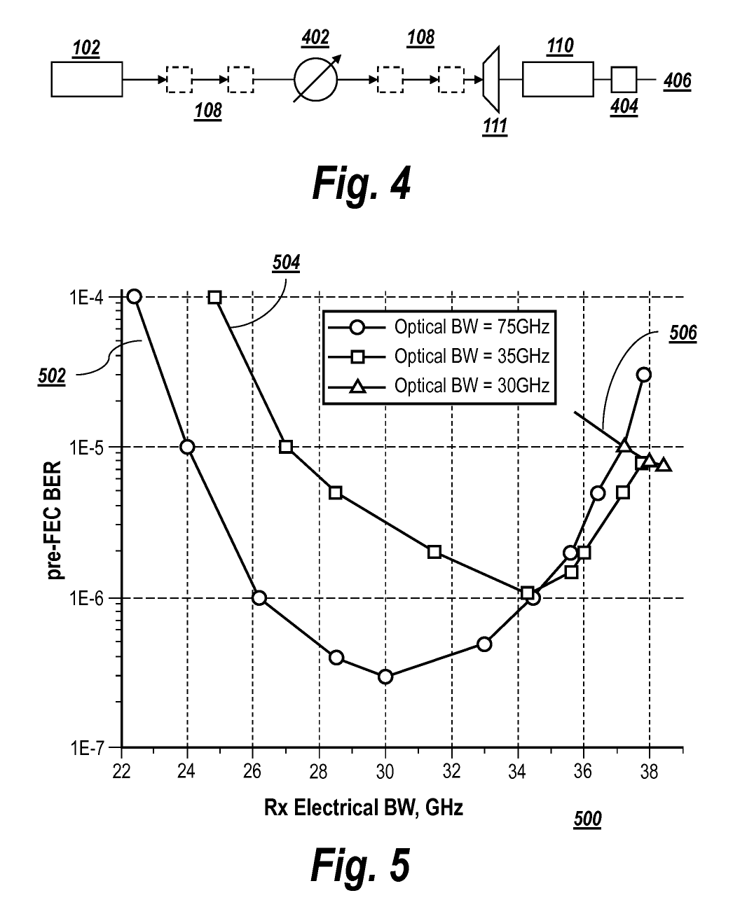

The above-described methodologies were verified in simulation and experimentally. For example, FIG. 4 is a block diagram depicting an experimental setup for evaluating a BER for various electrical and optical bandwidth combinations.

As shown in FIG. 4, the signal from a 43 Gbps DPSK transmitter 102 is passed through optical filters 108, and the signal is subjected to noise introduced by a noise-loading system 402. The noise-loaded signal is passed through further optical filters 108 and a demultiplexer 111 before being received by a DPSK receiver 110. By changing the number of cascaded optical filters 108 in the experiments, the inventors were able to vary the combined effective 3-dB optical bandwidth of the transmission line from about 30 GHz to 75 GHz.

The optical signal is processed by the receiver 110, which includes a trans impedance amplifier serving as an electronic device 140. The electrical output from the TIA is then directed to a clock and data recovery device (CDR) 404, the output of which is connected to a bit-error-ratio BER counter 406.

Within the receiver 110, DI interferometers with FSRs of 43 GHz, 50 GHz, 57 GHz and 66 GHz were tested. It was discovered that for a fixed value of DI FSR, the optimum performance of the receiver is achieved when the receiver electrical bandwidth BW_{eRX} changes when the combined effective optical bandwidth BWₒₚₜ of the transmission line changes: when BWₒₚₜ increases the optimal BW_{eRX} decreases and vice versa.

FIG. 5 is a graph 500 showing a relationship between the bit error ratio and various electrical and optical bandwidth combinations for a simulation using the experimental setup of FIG. 4. FIG. 5 shows measured pre-FEC BER at OSNR=16 dB versus the receiver electrical bandwidth for three different cases (502, 504, 506) of optical filtering BWₒₚₜ. As the graph 500 clearly illustrates, different values of optical bandwidth in the transmission line require different receiver electrical bandwidths to achieve a low BER. The receiver electrical bandwidth value which is optimal for a specific optical bandwidth may lead to significant penalties (i.e. in higher BER) when the optical bandwidth of the transmission line changes.

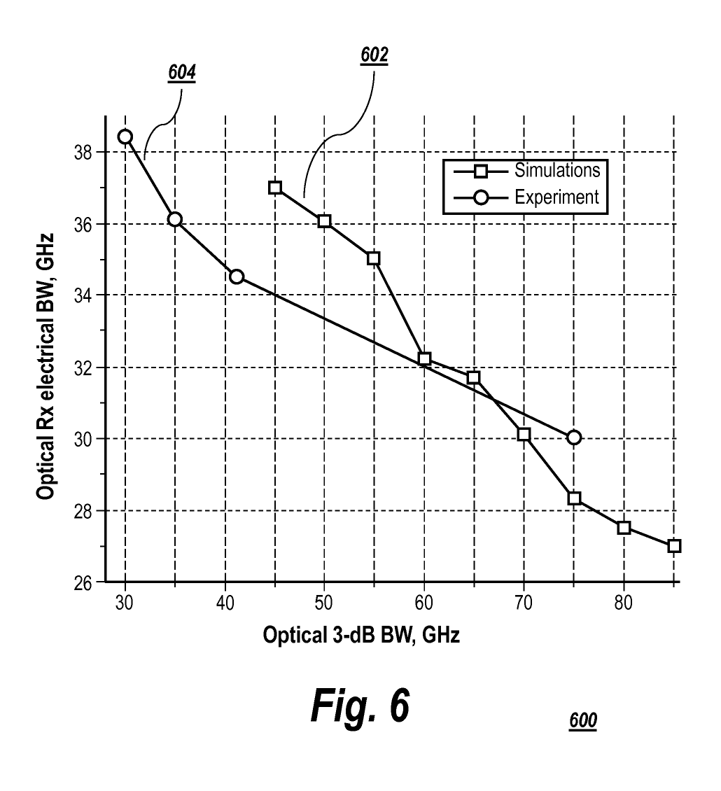

FIG. 6 is a graph 600 showing the relationship between the results of a simulation and an experiment in which the electrical bandwidth of the electronic device is varied in an inverse relationship to the optical bandwidth. That is, FIG. 6 shows numerically simulated (602) and experimentally measured (604) dependences of the optimal receiver electrical bandwidth BW_{eRX} vs the optical bandwidth BWₒₚₜ of the transmission line. As shown in FIG. 6, the theory and experiment achieve substantially similar results. Some differences observed between the theory and the experiment seen on the FIG. 6 are believed to be due to the fact that the theory assumes an ideal electrical Bessel-filter shape of the receiver, while in the experiment the actual spectral response of the receiver exhibits some ripples and a non-ideal shape.

The theoretical curve 602 shows that when the optical bandwidth is reduced from 85 GHz down to 45 GHz, the optimum BW_{eRX} increases from about 27 GHz to about 37 GHz. Accordingly, the receiver electrical bandwidth needs to be adjusted in a wide range with the transmission line optical bandwidth to achieve the optimal BER performance: the optimum BW_{eRX} increases from about 27 GHz to about 37 GHz (i.e. from about 0.6 B to about 0.86 B) when the optical bandwidth is reduced from about 85 GHz down to about 30 GHz for the case of DI FSR=50 GHz=1.16 B. Note that changing the DI FSR changes the optimal BW_{eRX}. With higher values of DI FSR, the required values of BW_{eRX} decrease for the same BWₒₚₜ, but the tendency remains the same—tighter optical filtering requires higher electrical bandwidth for optimal operation. Those of ordinary skill in the art will also recognize that for narrow optical filtering, the optimal RF bandwidths can be significantly greater than the widely used design targets for RF bandwidth for receivers with modulation formats such as DPSK and DQPSK.

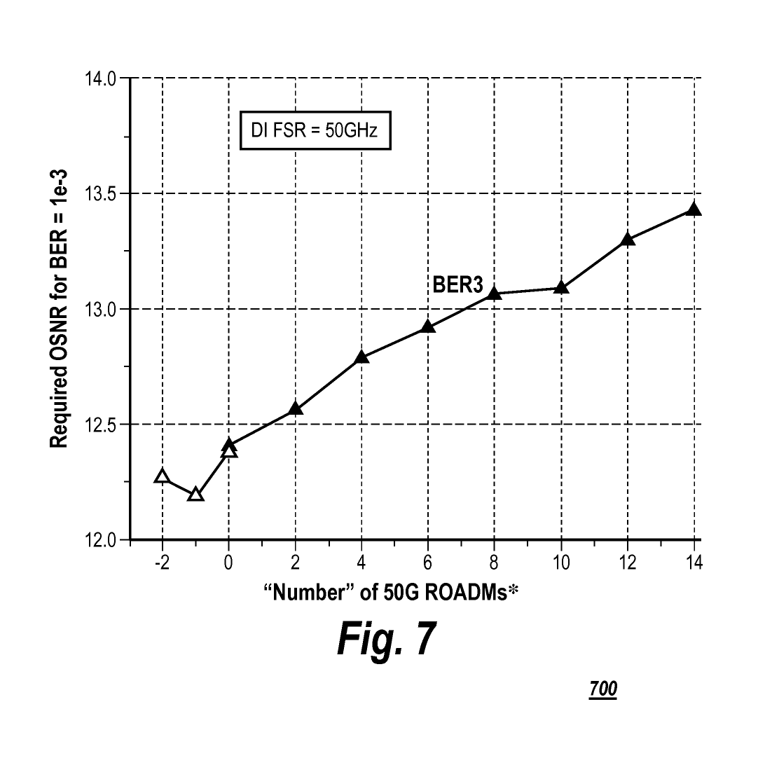

FIG. 7 is a graph 700 showing the performance of a 43 Gbps P-DPSK system with fixed DI FSR=50 GHz and adaptive Rx electrical bandwidth vs the strength of the optical filtering in the transmission line. As those of ordinary skill in the art will readily recognize, enhanced performance is achieved over a wide range of optical filtering conditions—from only one 100 GHz demultiplexer (3 dB BW=75 GHz, approximately 2^{nd}-order Gaussian shape) up to fourteen 50 GHz ROADMs in series with two 50 GHz interleavers (combined optical 3 dB bandwidth of about 30 GHz with about a 4^{th}-order Gaussian filter shape). OSNR sensitivity at a BER of 1e-3 changes by only less than 1.5 dB in such a wide range of optical filtering conditions without changing the DI FSR.

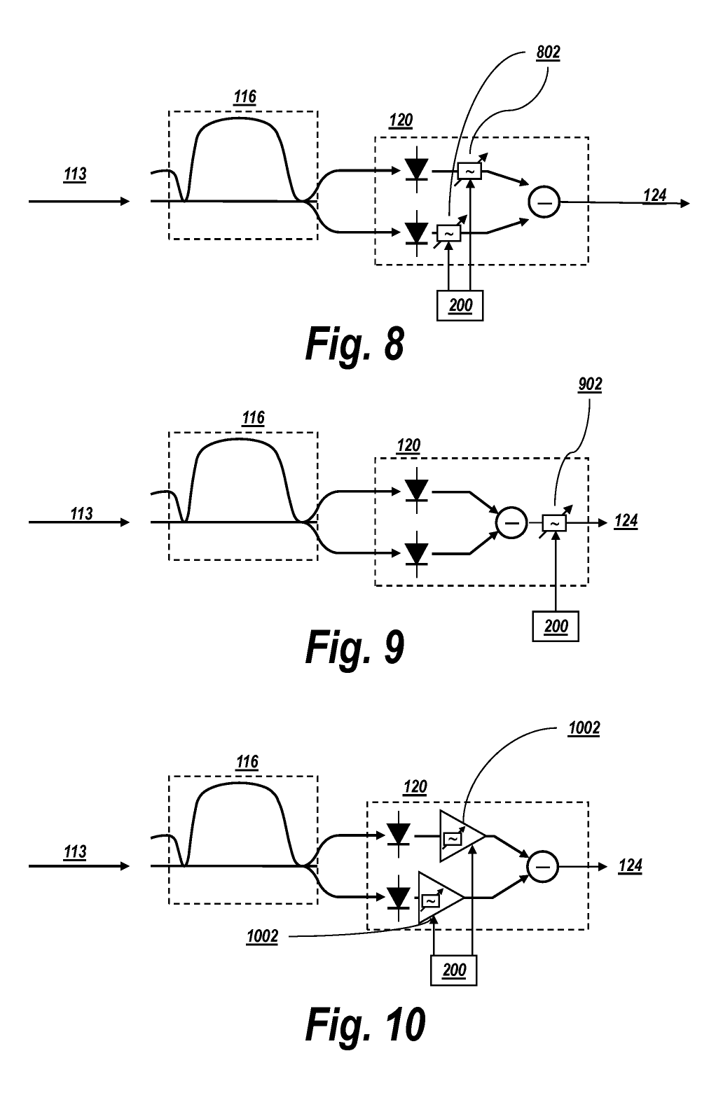

The electrical bandwidth can be varied using a number of different types of electronic devices in a number of different combinations. The electronic device 140 may receive electronic and/or optical inputs, and may output an electrical signal. For example, FIGS. 8-10 depict other exemplary embodiments of the present invention employing different electronic devices. In FIG. 8, a control device 200 controls the electrical bandwidth of two electrical filters 802, each respectively attached to an output of a detector in the photodetector 120. The electrical filters 802 each receive an optical input and provide an electrical output. The output of the electrical filters 802 are provided to a differencing unit for subtracting one output from the other. In FIG. 9, the outputs of the detectors are first subtracted by a differencing unit, and then provided to an electrical filter 902 which receives an electrical input and generates an electrical output. In FIG. 10, the outputs of the detectors are each respectively provided to a single-ended trans-impedance amplifier 1002 having adjustable bandwidths. The trans-impedance amplifiers 1002 may each receive an optical signal and output an electrical signal. The electrical signals output by the trans-impedance amplifiers 1002 may be subtracted from each other by a differencing unit.

In summary, it has been shown that when applying the concepts set forth herein of adaptive receiver electrical bandwidth, one can significantly improve the performance of DPSK receivers (both partial-DPSK and others) over a wide range of optical filtering. The same concept is applicable to mPSK and mQAM receivers with both direct detection and coherent detection schemes, and for NRZ and RZ cases. The same concept is also applicable to optical duo-binary format ODB (also known as phase-shaped binary transmission PSBT) and other direct-detection formats (on-off-keying, both RZ and NRZ).

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel. Moreover, although implementations have been described with particular emphasis on P-DQPSK, other modulation formats may also be employed.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, a computing device (e.g., a workstation) or a user of a computing device, unless otherwise stated.

The scope of the invention is defined by the claims and their equivalents.

1. A method for converting an optical signal transmitted in a transmission line of an optical communications network into an electrical signal, the method comprising:
receiving a first input signal at an electronic device, the first input signal representing data associated with the optical signal;
varying an electrical bandwidth of the electronic device in response to a characteristic associated with the optical signal; and
generating an output signal based on the varying of the electrical bandwidth.

2. The method of claim 1, wherein the optical signal is a Differential Binary Phase Shift Keying (DBPSK) modulated signal, a Differential Quadrature Phase Shift Keying (DQPSK) modulated signal, or a DmPSK optical signal.

3. The method of claim 2, wherein the varying of the electrical bandwidth further comprises varying the electrical bandwidth based on a combination of an optical bandwidth of the transmission line and a free spectral range of an interferometer associated with the electronic device.

4. The method of claim 1, wherein the first input signal is associated with a differential interferometer (DI) having a Free Spectral Range (FSR), and the FSR is fixed.

5. The method of claim 1, wherein the characteristic is determined from the optical signal.

6. The method of claim 1, wherein the characteristic comprises: a bit error rate of the optical signal, an optical bandwidth of the optical signal, a free spectral range of a differential interferometer coupled to the electronic device.

7. The method of claim 1, further comprising generating the first input signal from a differential interferometer, a photodetector, an electrical filter, or a differential detector.

8. The method of claim 1, wherein the electronic device comprises an amplifier, an electrical filter, or a photodetector.

9. The method of claim 1, wherein the transmission line is associated with an optical bandwidth, and the characteristic is an optical bandwidth of the transmission line.

10. The method of claim 9, wherein the optical bandwidth is a combined effective optical bandwidth that is based on a sum of an optical bandwidth of an optical signal as output by a multiplexer and respective optical bandwidths of one or more optical signals output by one or more optical filters in the optical network.

11. The method of claim 9, wherein the electrical bandwidth of the electronic device is varied in an inverse relation to the optical bandwidth.

12. The method of claim 1, further comprising receiving a second input signal at the electronic device, wherein:
the first input signal is output from a first optical detector and the second input signal is output from a second optical detector, and
generating the output signal comprises subtracting the first input signal from the second input signal.

13. The method of claim 1, wherein the varying of the electrical bandwidth further comprises varying the electrical bandwidth in response to a change in a bit error ratio (BER) associated with the electronic device.

14. A receiver for an optical communications network comprising a transmission line carrying a DPSK optical signal, the receiver comprising:
an optical interferometer coupled to receive the DPSK optical signal, the optical interferometer interfering the DPSK optical signal with itself, the optical interferometer outputting a first signal and a second signal;
a differential detector for providing an electrical signal responsive to a difference between the first signal and the second signal, the differential detector having a variable bandwidth and generating an output signal.

15. The receiver as in claim 14, wherein the variable bandwidth of the differential detector is varied in response to a characteristic of the optical signal.

16. The receiver as in claim 15, wherein the variable bandwidth is an electrical bandwidth.

17. The receiver as in claim 14, wherein the characteristic comprises: a bit error rate of the optical signal, an optical bandwidth of the optical signal, a free spectral range of a differential interferometer coupled to the electronic device.

18. The receiver as in claim 14, wherein the DPSK optical signal is a DmPSK optical signal.

19. The receiver as in claim 14, further comprising a controller coupled to the differential detector for adjusting the variable bandwidth in response to a characteristic of the optical signal.

20. The receiver as in claim 14, wherein the controller comprises an optical bandwidth determination unit for determining an optical bandwidth of the optical signal and an electrical bandwidth calculation unit for calculating a bandwidth to be applied at the differential detector based on the determined optical bandwidth.

21. The receiver as in claim 14, wherein the controller comprises a bit error ratio detection unit for determining a bit error ratio associated with the optical signal and an electrical bandwidth calculation unit for calculating a bandwidth to be applied at the differential detector.

22. A system for use in an optical network comprising a transmission line for transmitting an optical signal, the system comprising:
an electronic device for:
receiving a first input signal representing data associated with the optical signal, and
generating an output signal; and
an electronic device readable storage medium storing electronic device readable instructions that, when executed, cause the electrical bandwidth of the electronic device to vary in response to a characteristic associated with the optical signal.

23. The system of claim 22, wherein the electronic device is a trans-impedance amplifier (TIA).

24. The system of claim 22, wherein the electronic device is an electrical filter.

25. The system of claim 22, wherein the electronic device is an optical photodetector.

26. The system of claim 22, wherein the instructions cause the electrical bandwidth of the electronic device to vary in the range of about 20 GHz to about 39 GHz.

27. The system of claim 22, wherein the instructions cause the electrical bandwidth of the electronic device to vary in a range that is based on at least one of a bit rate of the optical signal and a modulation format of the optical signal.

28. The system of claim 22, wherein the electrical bandwidth of the electronic device is varied by applying a control voltage to the electronic device.

29. The system of claim 22, wherein the transmission line is associated with an optical bandwidth, and the characteristic is the optical bandwidth of the transmission line.

30. The system of claim 29, wherein the optical bandwidth is a combined effective optical bandwidth that is based on a sum of an optical bandwidth of a an optical signal as output by a multiplexer and respective optical bandwidths of one or more optical signals output by one or more optical filters in the optical network.

31. The system of claim 29, wherein the electrical bandwidth of the electronic device varies in an inverse relation to the optical bandwidth.

32. The system of claim 22, further comprising a first optical detector and a second optical detector provided in respective arms of a delay line interferometer (DLI).

33. The system of claim 22, wherein the optical signal is a modulated optical signal and is modulated according to one of the following formats: mPSK, DPSK, DmPSK, PDPSK, PDmPSK, mQAM, and ODB.
